(19) United States
(12) Patent Application Publication
(10) Pub. No.: US 2002/0106223 A1
(43) Pub. Date: Aug. 8, 2002

(54) In-line color printer having horizontal intermediate transfer belt

(76) Inventor: Robin P. Yergenson, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/776,008

(22) Filed: Feb. 2, 2001

(51) Int. Cl. G03G 15/01

(52) U.S. Cl. 399/298; 399/299; 399/302; 399/405

(57) ABSTRACT

An inline electrophotographic color printer having a developing section configured to receive a plurality of removable color toner cartridges and an intermediate transfer device is configured to receive color toner from the color toner cartridges. A feed tray receptacle is configured to receive a finished product medium feed tray containing finished product medium onto which an electrophotographic color image can be printed. A finished product medium feed path is configured to move finished product medium from the feed tray past the intermediate transfer device to allow toner from the intermediate transfer device to be transferred to the finished product medium. The feed tray receptacle is positioned below the intermediate transfer device, and the finished product medium feed path is configured to pass finished product medium past the intermediate transfer device in a substantially vertical direction.

### FIELD OF THE INVENTION

The invention claimed and disclosed herein pertains to in-line electrophotographic color printers, and in particular to an arrangement of an intermediate transfer belt and a paper feed path in such a printer which results in a relatively compact sized printer.

### BACKGROUND OF THE INVENTION

In-line color printing by an electrophotographic printer is achieved by building a final image on a finished product medium (such as a sheet of paper) using a plurality of color toners. The color toners are fist individually applied to associated photoconductors. Each toner is then subsequently transferred from its associated photoconductor onto an intermediate transfer medium. Finally, the toners are transferred from the intermediate transfer medium onto the finished product medium.

A typical electrophotographic (“EP”) printing process uses the following toner colors to produce the final images: black, yellow, cyan and magenta. The final image, which is a collection of printed “pixels” or dots, can be made up of pixels printed with a single color toner (e.g., a black pixel), pixels printed using two or more color toners applied on top of one another to produce a different color (e.g., yellow over cyan to produce green), and pixels which are not printed (that is, which have no toner applied to them). The unprinted pixels result in the pixel being the color of the finished product medium, as for example “white” when the finished product medium is white paper.

More specifically, a printed image for an electrophotographic printer is built up by scanning selected portions of a digitized image onto selected ones of the plurality of photoconductors. The digitized image is comprises image data which is stored in an electronic readable memory device. The image data is stored in the memory device in a matrix form, or a “raster”, which identifies the location and color of each pixel which will comprise the final image. The raster image data can be obtained by scanning an original analog document and digitizing the image into raster data, or by reading an already digitized image file into the memory device. The former method is more common to photocopiers, while the latter method is more common to printing computer files using a printer, and each of these methods is within the scope of EP color printing. In any event, the image to be printed onto tangible media (the final product medium) is stored as a digital image file. The digital image data in the file is then used to pulse the beams from a plurality of lasers, as described more fully below, so that the image can be reproduced by the electrophotographic printing apparatus.

The raster image data file is essentially organized into a two dimensional matrix. The image is digitized into a number of lines. Each line comprises a number of discrete dots or pixels across the line. Each pixel is assigned a binary value containing information pertaining to the pixel color and potentially other attributes, such as density. The combination of lines and pixels makes up the resultant image. The digital image is stored in the memory device as a raster image. That is, the image is cataloged by line, and each line is cataloged by each pixel in the line. A computer processor reads the raster image data line by line, and selectively actuates the lasers to expose pixels on the associated photoconductors based on the presence or absence of coloration, and the degree of coloration for the pixel. This process is known as the “scanning process”.

In the scanning process, each of a plurality of dedicated lasers are scanned from one edge of an associated photoconductor to the opposing edge, and the laser is selectively actuated or not actuated on a pixel-by-pixel basis to scan a line of the image onto the associated photoconductor. The photoconductor advances and the next line of the image is scanned by the laser onto the photoconductor. More than one laser can be actuated simultaneously so as to more quickly generate the parsed image onto the plurality of photoconductors. The side-to-side scanning of each laser is traditionally accomplished using a dedicated rotating polygonal multi-faceted mirror. The laser beam impinges on one facet of the polygonal mirror and is reflected to a secondary or deflector mirror, which directs the laser beam to a unique, relative lineal position on the light sensitive surface of the associated photoconductor. By “relative”, it is understood that the photoconductor moves with respect to the linear position, but the position remains fixed in space. As the polygonal mirror rotates, the angle of incidence, and hence the angle of reflection, of the laser beam will vary. This causes the laser beam to be scanned across the photoconductor at the unique relative lineal position from a first edge to a second edge of the photoconductor. As the mirror rotates to an edge of the polygon between facets, the laser is essentially reset to the first edge of the photoconductor to begin scanning a new line onto the advancing photoconductor.

Each photoconductor is covered with a photoconductive material which is capable of being electrically charged and discharged to various electrical potentials on a highly localized basis. The localization of the electrical charges corresponds to pixels in the raster image. Each photoconductor is initially electrically charged to a base potential (or voltage) which does not attract color toner. The photoconductor is then selectively discharged (or not discharged) on a pixel-by-pixel basis by the associated laser, as described above. As the laser is scanned across the photoconductor, the laser is pulsed on or off in a selective manner corresponding to the raster image, thus selectively discharging or not discharging the pixels on the photoconductor. The discharged portions of the photoconductor will attract the associated color toner to the photoconductor, and the charged portions will not attract color toner to the photoconductor. This process of selectively discharging the photoconductors is known as the exposure process, and is performed by the scanning section of the printer.

As described above, each photoconductor has an associated color toner, which is made available to the photoconductor via a toner hopper. The toner typically consists of small colored plastic spheres capable of being charged with an electrical potential so as to be attracted to the exposed portions of the associated photoconductor. The individual toner hoppers, toners, and associated photoconductors are each typically provided in an integral unit known as a “toner cartridge” or a “developer station”.

After the toner particles of the different toners are applied to the associated photoconductors, they are thereafter transferred to an intermediate transfer device which passes by each of the photoconductors, such that the image is thus built up on the intermediate transfer device. The transfer is accomplished by applying an electrical charge at each photoconductor which attracts the toner from the photoconductor to the intermediate transfer device. One example of an intermediate transfer device is a continuously rotating belt. Such a device is known as an intermediate transfer belt (“ITB”). After the image is built up on the intermediate transfer device, it is subsequently transferred to the finish product medium. This transfer can be effected by applying an electrical potential to attract the toner away from the ITB to the finished product medium. After the toner is applied to the finished product medium it is fixed on the product medium by means such as pressure, heating, or a combination of the two. The combination of the individual developer stations and the ITB is known as the “developing section” of the printer, and is to be distinguished from the “scanning section”, described above.

It is understood that the above description of the electrophotographic printing method used in an in-line color printer is a general description, and that variations within the apparatus can be employed to equal effect. For example, it is not necessary to have a dedicated rotating mirror for each developer station, and that by strategic arrangement of the laser diodes and mirrors, a single rotating mirror can direct two or more laser beams to different developer stations.

It is also understood that the technology to which the invention described below is applicable to any electrophotographic imaging device, such as photocopiers, printers, and facsimile machines. Recent technology has removed the distinction between one type of imaging device and another, such that a single imaging apparatus can be used either as a copier, as a printer for computer files, or as a facsimile machine. These apparatus are known variably as multifunction printers (“MFPs)”, or “all-in-one” devices, terms indicating the ability to act as a photocopier, a printer, or a facsimile machine. Accordingly, when we use the expression “printer” in the following discussion it should not be considered as limiting the invention to a device for printing a file from a computer, but should also be understood to include a photocopier capable of printing a digitized image of an original document as well as a facsimile machine. Further, the term “original documents” includes not only already digitized documents such as text and image files, but photographs and other images, including hybrid text-image documents, which are scanned and digitized into raster data.

Turning now to FIG. 1, a simplified schematic diagram of a prior art EP printer 100 is shown in side elevation view. The printer 100 comprises an enclosure 102 which houses a scanning section 110, a developing section 120, and a paper feed section 170. The printer also includes a control section (not shown), which coordinates and actuates the other sections. The scanning section 110 contains scanning lasers and rotating mirrors (not shown) to direct the laser beams A, B, C and D to respective developer stations 122, 124, 126 and 128 in the developing section 120. Stationary mirrors 134 and 136 are used respectively to guide laser beams B and D to photoconductors at respective developer stations 124 and 128. Developer station 122 is exemplary of the other developer stations, and contains a rotating photoconductor 125 and a toner hopper 123 for containing a color toner (not shown). Toner which is transferred to the photoconductors is subsequently transferred to an intermediate transfer belt (ITB) 130 by electrostatic units 138. The ITB is supported by rollers 132, and is driven in direction “M” by a drive unit (not shown).

The paper feed section 170 of the printer 100 includes a paper supply feed tray 140 for holding a plurality of sheets of paper P, and a paper discharge tray 160 for receiving final printed sheets of paper P3. Paper P is pulled from the feed tray 140 and moved past the ITB 130 by a driven feed rollers 142. As a sheet of paper P1 passes the ITB 130, toner from the ITB is attracted to the paper P1 by the electrostatic unit 144. A paper guide 146 directs the paper to fusing rollers 148 which in turn fuse the toner to the sheet of paper, as indicated by sheet P2. The finished, printed sheet of paper is then moved by driven rollers 152 and paper supports 154 to the discharge tray 160, where it can be accessed by a user.

A study of FIG. 1 reveals the following short-comings with the prior art electrophotographic printer design. First, paper jams can be difficult to clear. For example, a sheet of paper, such as sheet P2, can becomes jammed in the paper path 170 as a result of the sheet lifting above one of the rollers 152, rather than staying between adjacent rollers. Typically access to the paper path is provided by way of an access door in the same end of the printer as the discharge tray, which would be end 182 in FIG. 1. As is evident, gaining access to sheet P2 would be extremely difficult in this situation due to the small vertical space provided between the ITB 130 and the bottom of the printer. One solution to this problem is to provide a side access door in the printer 10, rather than, or in addition to, an end access door. The primary drawback to this solution is that frequently printers are located in areas where front access to the printer (i.e., access to end 182) is available so that printed pages can be easily retrieved, but side access is compromised. For example, a printer in a home use environment is frequently located in a printer cabinet which provides space for air circulation around the printer, but does not allow sufficient room for a side access door to be opened and a user to access the paper path. In this situation the user would need to rotate the printer ninety degrees in the cabinet to gain access.

A second problem with the prior art configuration depicted in FIG. 1 is that the design dictates that the overall exterior dimensions of the printer be rather large. For example, the surface area required to accommodate the printer (i.e., the “footprint”) is defined by the length “L” of the printer 100 and the width of the printer (not visible in the view shown). The length “L” of the printer is dictated not only by the length of the housing 102, but also by the extension of the paper discharge tray 160 beyond the housing 102. Further, the configuration of the paper feed tray 140 adds additional length to the housing 102. In like manner, the height “H” of the printer 100 is defined by the internal components of the printer (scanning section 110, developer section 120, and paper path 170), as well as the distance that the paper P in the paper feed tray 140 extends beyond the top 103 of the printer. For obvious reasons, it is desirable to minimize the footprint of the printer, as well as the height of the printer. This is particularly so in a home use environment where the available storage space for a printer may be limited by the dimensions of a computer hutch or the like.

An additional problem with the configuration of the prior art printer 100 is that it requires a user have free access to both ends of the printer. That is, a user should have access to end 182 to removed printed sheets from the discharge tray 160, as well as to end 183 to add paper to the feed tray 140. This can be accomplished by locating the printer on a shelf allowing access to end 182, as well as to the top of the printer so that paper can be added to the feed tray 140 from the top. However, this essentially requires locating the printer 100 on the top shelf of a computer cabinet or on the top of a desk. That is, locating the printer on a lower shelf would obstruct access to the paper feed tray 140. The design depicted in FIG. 1 thus severely limits the available locations in which a printer can be located. Further, this location restriction that the printer be located on a top shelf or a desk top reduces the likelihood that the printer can be stored out-of-sight when not in use, and generally does not allow the printer to be stored in an enclosed cabinet to protect the printer from dust and the like.

What is needed then is a color in-line laser printer which provides a relatively small footprint and is of a modest height, and also allows a user access to the paper path, the paper trays, and the toner cartridges.

### SUMMARY OF THE INVENTION

The present invention provides for an inline electrophotographic color imaging apparatus (a “printer”) for printing a color image onto a finished product medium, The components of the printer are arranged such that the printer occupies a relatively small area when resting on a supporting surface, and access to the various components of the printer is facilitated for maintenance and the like.

A first embodiment of the invention includes an inline electrophotographic color imaging apparatus configured to be supported by an essentially horizontal surface. The imaging apparatus includes a developing section configured to receive a plurality of removable color toner cartridges, and an intermediate transfer device configured to receive color toner from the color toner cartridges. The printer has a feed tray receptacle configured to receive a finished product medium feed tray, which in turn is configured to containing the finished product medium. A finished product medium feed path is configured to move finished product medium from the feed tray past the intermediate transfer device to allow toner from the intermediate transfer device to be transferred to the finished product medium. The feed tray receptacle is positioned below the intermediate transfer device, and the finished product medium feed path is configured to pass finished product medium past the intermediate transfer device in a substantially vertical direction relative to the essentially horizontal surface.

Preferably, the intermediate transfer device is a continuous, rotating belt which moves past the color toner cartridges and at least a portion of the finished product medium feed path. More preferably, the color toner cartridges are oriented in a substantially horizontal direction relative to the essentially horizontal surface. The printer can further include a finished product medium discharge tray. In this case, the finished product medium feed path is configured to discharge finished product medium in the discharge tray after the finished product medium has moved past the intermediate transfer device. Preferably, the discharge tray is positioned above the intermediate transfer device, and more preferably is oriented in a substantially horizontal direction relative to the essentially horizontal surface. More preferably, the discharge tray is located in a position substantially in vertical alignment with the feed tray receptacle.

The printer can further include a second feed tray receptacle which is essentially parallel to the first feed tray receptacle and functions in a manner similar to the first feed tray receptacle. This allows different sizes or colors of finished product media to be used in the printer. The printer can also include a third source for finished product media. The third source can be a feed receptacle configured to receive finished product medium directly. When the printer is enclosed within a housing, the third source can be hingedly attached to the housing, and the housing can define an opening allowing finished product medium to pass from the feed receptacle into the feed path.

The invention also provides for a method of printing an electrophotographic image on a finished product medium. The method includes providing the finished product medium onto which the electrophotographic image is to be printed, and providing an intermediate transfer medium configured to support a plurality of color toners. The color toners will be used to generate the electrophotographic image on the finished product medium. A finished product receptacle is also provided, which is configured to contain the finished product medium after the electrophotographic image has been printed onto the finished product medium. A plurality of color toners are selectively deposited onto the intermediate transfer medium to generate a representation of the image on the intermediate transfer medium. The finished product medium is initially orienting in a substantially horizontal position, and is then moved from the substantially horizontal position to a substantially vertical position while being moved past the intermediate transfer medium. Color toner from the intermediate transfer medium is transferred to the finished product medium as it moves past the intermediate transfer medium. The finished product medium is then moved from the substantially vertical position to a substantially horizontal position and is placed in the finished product receptacle.

Preferably, in the method the intermediate transfer medium is moved in a substantially horizontal direction while the plurality of color toners are deposited onto the intermediate transfer medium. More preferably the intermediate transfer medium is moved in a substantially vertical direction while the color toner is transferred from the intermediate transfer medium to the finished product medium. Further, the finished product medium is preferably placed in the finished product receptacle in a position substantially vertically aligned with the initial position in which the finished product medium was oriented.

These and other embodiments of the present invention will now be described in fuller detail and with reference to the accompanying figures, in which:

### DESCRIPTION OF THE DRAWINGS

FIG. 1 is a side elevation schematic diagram depicting an electrophotographic inline color printer of the prior art.

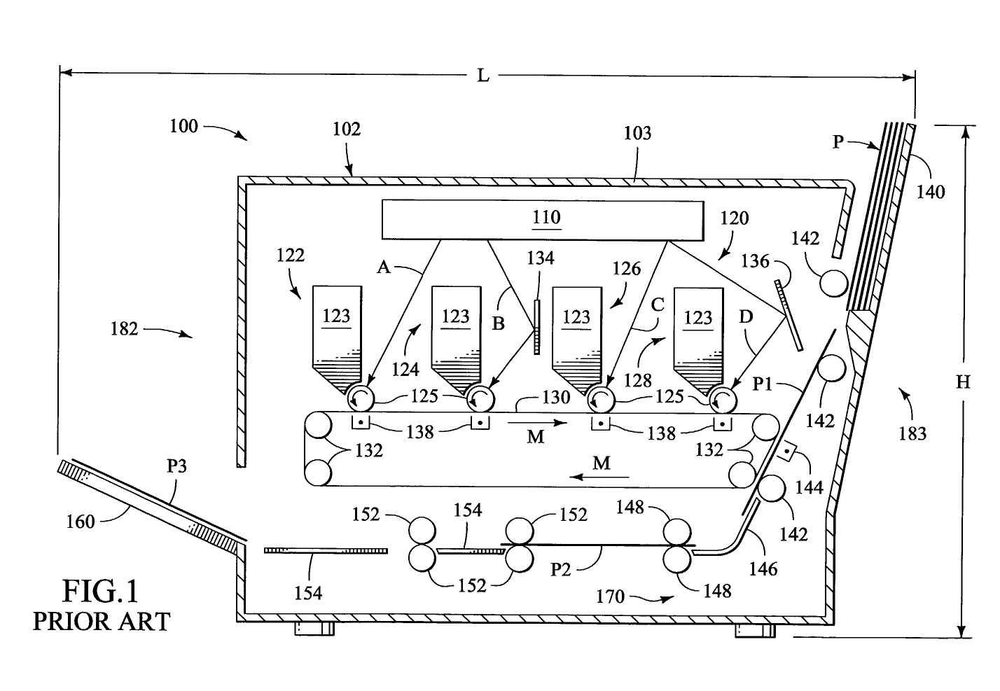

FIG. 2 is a front elevation schematic diagram depicting a first embodiment of an electrophotographic inline color printer in accordance with the present invention.

FIG. 3 is a another front elevation schematic depicting diagram the electrophotographic inline color printer of FIG. 1.

FIG. 4 is a front elevation schematic diagram depicting a second embodiment of an electrophotographic inline color printer in accordance with the present invention.

### DETAILED DESCRIPTION OF THE INVENTION

The present invention discloses an inline electrophotographic color imaging apparatus having an efficient arrangement of components to produce an imaging apparatus which is compact in size and provides ease of access to components for maintenance. Specifically, the arrangement of components in the imaging apparatus results in the apparatus occupying a relatively surface area when resting on a surface. The present invention also discloses a method of printing a color image onto a finished product medium using an electrophotographic imaging process which produces the benefits just discussed with respect to the apparatus.

The present invention pertains to inline electrophotographic (“EP”) color imaging apparatus, which, as discussed in the Background section, can included printers, copies, facsimile machines, and devices which perform some or all of these functions. For the sake of simplicity, I will use the expression “printer” in the following discussion to refer to all of these devices separately and collectively. However, it is understood that the invention is not limited to a “printer” per se, but covers all such EP imaging apparatus.

The imaging apparatus of the present invention are intended to generate an image on various types of finished product media, including by way of example only paper and clear transparencies make from plastics. From time to time in the following discussion I may use the expression “paper” when referring to finished product media, but it is understood that the invention is not limited to “paper” finished product media, but is intended to work will all types of printable finished product media.

An exemplary processes for generating a color image on finished product media using a scanning section, a developing section, and an intermediate transfer device was generally described above in the Background section. This process, and other electrophotographic processes which accomplish the same objective of generating a color image on finished product, are well understood in the art. Accordingly, I will not describe these processes in detail in the following discussion. It is understood however that the invention should be considered as capable of using any known or future types of scanning sections and developing sections and processes for EP imaging.

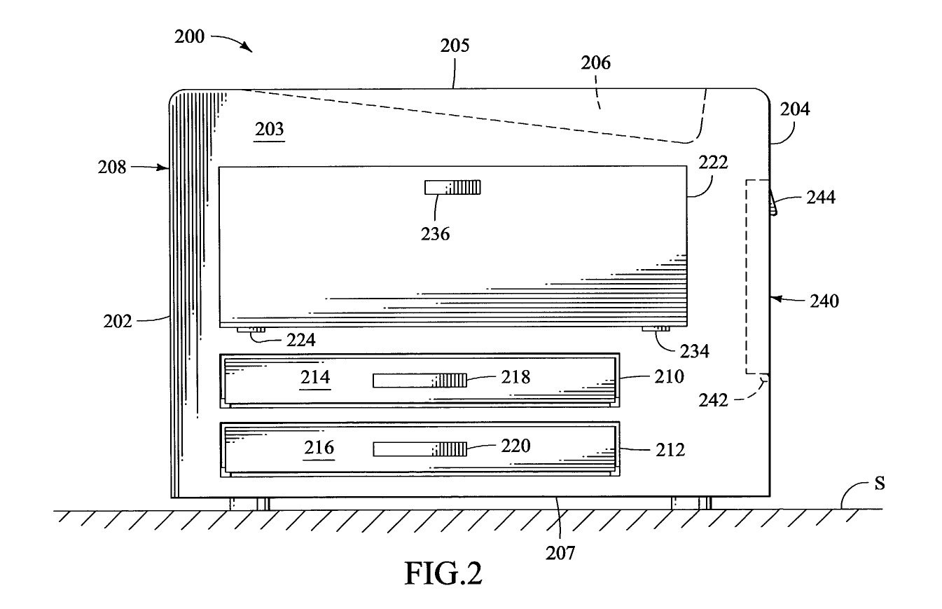

Turning to FIG. 2, a first embodiment of a printer 200 in accordance with the present invention is depicted in front elevation view. The printer 200 is configured to be supported on an essentially horizontal surface “S”. The printer has a housing 208 which encloses the various components of the printer. The housing can be fabricated from plastic, metal, carbon fibre, or other components, or any combination thereof. The printer housing 208 defines a front side 203, a left side 202, a right side 204, and a back side (not visible in this view). The printer housing further defines a top 204 and a bottom 207. Disposed within the front 203 of the printer housing 208 are a first feed tray receptacle 210 and a second feed tray receptacle 212. The feed tray receptacles are essentially openings in the housing allowing a finished product medium feed tray to be inserted into the printer 200. Two exemplary feed trays are depicted as first feed tray 214 in feed tray receptacle 210, and second feed tray 216 in feed tray receptacle 212. The feed trays themselves are configured to contain or hold finished product medium. Accordingly, I will use the expression “paper tray” for the sake of simplicity to refer to a finished product medium feed tray. The paper trays 214 and 216 are configured to be removed from the printer 200 using respective handles 218 and 220 so that they can be filled with paper, or the paper within the tray can be changed to another type of finished product medium (such as transparencies). Although the invention does not require two paper trays to be used, and can in fact be implemented using only a single paper tray, the use of two paper trays allows a user to switch between two different types of media, for example, between size A4 paper and 8.5 inch by 11 inch paper. Preferably, the paper trays 214 and 216 are received within the printer 200 in a position which is substantially parallel to the horizontal surface S upon which the printer is intended to be supported.

Although using removable paper trays is the preferred embodiment of providing finished product medium to the printer 200, it is understood that other means for providing finished product medium to the printer can be employed. For example, paper could be inserted directly into receptacles 210 and 212. Thus, I will use the expression “finished product medium receptacle” or “feed receptacle” to indicate any structure which allows finished product medium to be provided to the printer.

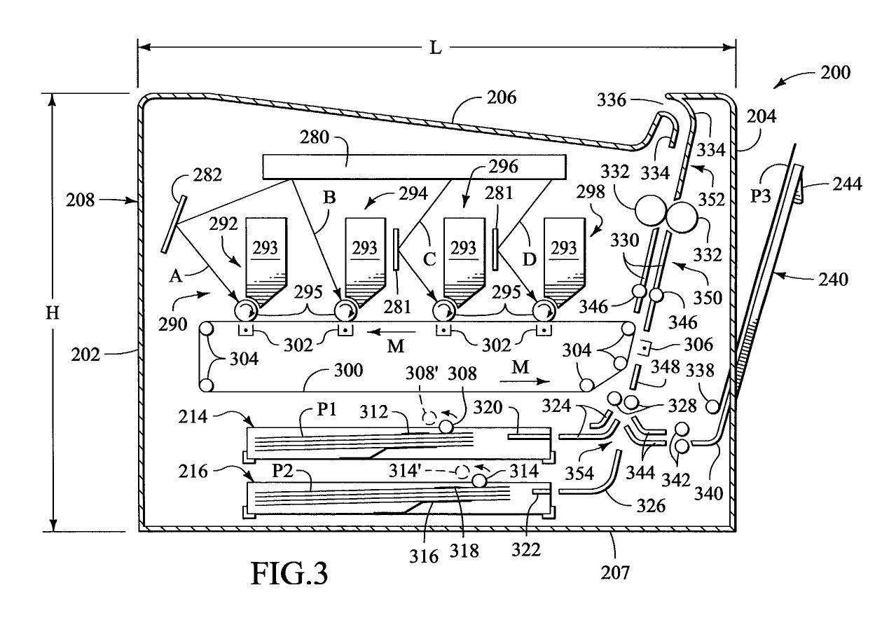

The printer 200 can further include a third finished product medium receptacle 240 which is located in the right side 204 of the printer 200. The third receptacle 240 may be known as a “bypass tray”, and allows a third type of product medium to be provided to the printer 200 beyond that provided by paper trays 214 and 216. Preferably, the third receptacle is hingedly attached to the printer housing 208 so that it can be deployed (as indicated in FIG. 3) using handle 244 to receive finished product medium when required. The third receptacle can be useful for example when only a small number of images need to be printed onto a finished product medium different from that in the paper trays 214 and 216. An opening within the side 204 of the housing 208 allows printable media to pass from the third receptacle into the printer for printing.

The printer 200 can further include an access panel 222 which is placed over an opening (not shown) in the housing 208. The access panel 22 can be hinged to the housing 208 using hinges 234, and can be opened using handle 236. Opening the access panel 222 provides access to the internal components of the printer 200, such as the toner cartridges 292, 294, 296 and 298 of FIG. 3, as well as the paper path 350 of FIG. 3. This allows the toner cartridges to be replaced when toner is depleted, and to clear paper jams from the paper path 350.

The printer 200 of FIG. 2 also includes a finished product medium receptacle 206 which is formed within the housing 208 and is configured to receive sheets of finished product media after they have been printed with an image. The finished product medium discharge tray 206 is oriented such that it receives and holds sheets of printed media in an orientation substantially parallel to the horizontal surface S upon which the printer is intended to be supported. By “substantially horizontal” I mean that the sheets of printed media are supported in the discharge tray 206 at an angle of not more than 40 degrees to the horizontal surface S, and preferably at an angle of about 15 to 30 degrees.

Turning now to FIG. 3, the printer 200 of FIG. 2 is again depicted in a front elevation view. However, in FIG. 3 the front 203 of the housing 208 of FIG. 2 has been removed to expose the internal components of the printer 200. These components include a scanning section 280, a developing section 290, an intermediate transfer device 300, and a finished product medium feed path 350. The scanning section 280 includes a plurality of scanning laser diodes (not shown) and at least one rotating polygonal mirror to direct beams of energy from the lasers to the developing section 290. The general operation of a scanning section was described in the Background section, and so the operation of the scanning section 280 need not be described further. However, the scanning section 280 is preferably selected to provide a relatively low vertical profile to aid in reducing the overall height of the printer 200. The use of a scanning section which uses a single rotating polygonal mirror to direct multiple laser beams can help to reduce the height of the scanning section. The scanning section 280 generates selectively pulsed beams of energy A, B, C and D which are directed to dedicated photoconductors in the developing section 290. Beam A is reflected by mirror 282, and beams C and D are reflected by respective mirrors 281 to allow for a more compact scanner section design.

The developing section 290 of the printer 200 includes a plurality of developer stations 292, 294, 296 and 298. Each developing station is preferably a removable color toner cartridge. Developing station 294 is an exemplary removable toner cartridge and includes toner hopper 293 for containing a color toner, and a rotatable photoconductor drum 295. The photoconductor 295 acts in the manner described in the Background section, and is selectively exposed by laser beam B, and attracts color toner from the hopper 293 to the selectively exposed portions. The toner from the photoconductor 295 is then attracted to the intermediate transfer device 300 using the toner transfer module 302. The toner transfer module 302 basically comprises an electrical wire which can be used to generate an electrical field attracting toner from the photoconductor 295 to the intermediate transfer device 300. Each toner cartridge 292, 294, 296 and 298 has an associated toner transfer module 302 to attract toner from the photoconductor in the cartridge to the intermediate transfer device. While the printer 200 is depicted as having four toner cartridges, a larger or lesser number can also be employed. Typically, for a four-color inline printer, the toner cartridges will include a cartridge having a toner which is yellow in color, a cartridge having a toner which is cyan in color, a cartridge having a toner which is magenta in color, and a cartridge having a toner which is black in color. As described above, these four colors can be used separately and in combination to generate a relatively large palate of colors and tones for the finished product image.

The intermediate transfer device 300 receives toner from the photoconductors and conveys the collective toners to a point where the toners can be transferred to the finished product medium. This transfer is affected by the toner transfer device 306 which is located adjacent to the paper path 350. The intermediate transfer device 300 comprises an intermediate transfer medium which is configured to support the toners in a stable, fixed position on the transfer device until the toner is transferred to the finished product medium. As depicted in FIG. 3, the intermediate transfer device comprises a continuous, rotating belt 300 which is supported by rollers 304 and moves in direction “M”. One or more of the rollers 304 can be power driven to cause the belt 300 to move in the direction indicated.

Exemplary finished product medium feed trays 214 and 216 are depicted in FIG. 3. Feed tray 214 is depicted as containing finished product media P1, while feed tray 216 is depicted as containing finished product media P2. Media P1 can be for example paper which is 8.5 inches wide by 11 inches long, while media P2 can be for example paper which is 210 mm wide by 297 mm long (“A4” paper). The media in tray 214 is biased in an upward position by spring 310, but is held in the tray by retaining plate 312. Likewise, the media in tray 216 is biased in an upward position by spring 316, but is held in the tray by retaining plate 318. Media in tray 214 is removed from the tray by a drive roller 308, which is configured to retract to position 308′ when the tray is removed to allow free movement of the tray out of the printer 200. Likewise, media in tray 214 is removed from the tray by a drive roller 314, which is configured to retract to position 314′ when the tray is removed to allow free movement of the tray out of the printer 200. As paper is driven out of tray 214 and 216, respective guide plates 320 and 322 direct the paper into the paper feed path 350 (described below). Bypass finished product medium receptacle 340 is depicted as holding finished product medium P3 which can be urged into the paper feed path 350 using drive roller 338.

Preferably, the paper discharge tray 206 is located above the scanning section 280, which is located above the developing section 290, which is in turn located above the intermediate transfer device 300, which is located above the paper feed trays 214 and 216. Also preferably, the developer stations 292, 294, 296 and 298 are oriented in substantial horizontal alignment with the surface S on which the printer 200 is to be supported. Likewise, the paper feed trays are preferably oriented such that media contained by the trays is substantially horizontally aligned with the surface S. The intermediate transfer belt 300 is preferably arranged such that the major length axis is along a horizontal line essentially parallel to the surface S. Finally, the paper discharge tray 206 is preferably substantially horizontally oriented. This preferred configuration of the listed components acts to reduce the overall height of the printer 200 compared to other arrangements of the components. More preferably, the paper discharge tray 206, the scanning section 280, the developing section 290, the intermediate transfer device 300, and the paper feed trays 214 and 216 are all substantially vertically aligned. By “substantially vertically aligned” I mean that the side-to-side dimension of any two of the named components in combination is minimized within the constrains dictated by the overall printer design.

The printer 200 further includes a finished product medium feed path 350, which will be referred to herein as the “paper feed path” for the sake of simplicity.

The paper feed path 350 acts to guide finished product medium from the finished product medium feed trays 214 and 216 past the toner transfer module 306 so that toner can be transferred from the intermediate transfer device 300 to the finished product medium. The paper feed path 350 then moves the finished product medium past a fusing station 346 which is configured to fuse the toner to the product medium using heat, pressure, or a combination of the two. Finally, the paper feed path moves the finished product medium into the paper discharge tray 206 where it can be retrieved by a user. The paper feed path is defined by a finished product medium input area 354 and a finished product medium output area 352. Finished product media enters the paper feed path 350 at the input area 354 and leaves the paper feed path at the output area 352. A discharge receptacle guide 334 acts to guide the finished product medium from the output area 352 into the discharge receptacle 206.

Finished product media enters the paper feed path input area 354 from one of the paper trays 214 or 216, or the bypass tray 240. In the case of paper tray 214, when an image is to be printed on a sheet of finished product medium contained within this tray, drive roller 308 urges the sheet towards the paper guides 324 which direct the sheet into the input area 354. Likewise, in the case of paper tray 214 drive roller 314 urges a sheet of medium from the tray towards the paper guide 326 which directs the sheet into the input area 354. With respect to finished product medium receptacle 240 (the bypass tray), initial drive roller 338 urges a sheet of media from the receptacle towards paper guide 340. Paper guide 340 directs the sheet towards drive rollers 342 which drive the sheet towards paper guides 344, which in turn guide the sheet into the paper feed path input area 354.

Once a sheet of finished product medium has entered the paper feed path 350 at the input area 354, drive rollers 328 engage the sheet and move it in a generally upward, substantially vertical direction towards the intermediate transfer belt 300. Paper guide 348 aids in keeping the sheet of medium in proximity to the transfer belt 300. As the sheet passes between the transfer belt and the toner transfer module 306, the module causes toner to be transferred from the transfer belt to the finished product medium. Fusing rollers 346 then fuse the toner to the sheet. Paper guides 330 act to guide the sheet in a generally upward direction towards the output area 352. Additional drive rollers 332 can be used to move the sheet towards the output area 352.

While the paper path 350 has been described in one particular configuration, it is understood that the invention should not be limited to this implementation. Various means for configuring a paper feed path for moving a sheet of finished product medium past a transfer belt and a fusing station are well known and can be used to equal effect. For example, the drive rollers 328 and 332 can be replaced with a moving friction belt to urge the sheet upward through the feed path. Likewise, additional drive rollers beyond those shown can be employed to accommodate small paper dimensions. Further, the paper guides 348, 330 and 352 can be a single continuous plane on each side of the feed path with openings provided in the planes to allow a drive mechanism (such as rollers or belts) to engage the sheet and drive it through the paper path 350.

Preferably, the finished product medium feed path 350 is oriented such that 20 a sheet of finished product medium traveling in the feed path between the input area 354 and the output area 352 travels in a substantially vertical direction with respect to the surface S on which the printer 200 is intended to be supported. By “a substantially vertical direction” I mean that a sheet of medium in the feed path is perpendicular to, or at an angle of not more than about 35 degrees from normal to, the horizontal surface S. A substantial vertical orientation of the paper feed path 350, in conjunction with the preferred arrangement of the other components as described above, aids in reducing the surface area which will be occupied by the printer 200 on the supporting surface S.

As can be seen from a review of FIG. 3, the first embodiment of a printer 200 in accordance with the present invention results in an inline color electrophotographic imaging apparatus which has a relatively short overall height H, and a relatively short length L. This is achieved by the essentially horizontal alignment of the following components: the paper discharge tray 206, the scanner section 280, the toner cartridges 292, 294, 296 and 298 in the developing section 290, the transfer belt 300, and the paper trays 214 and 216. The compact design is further aided by the substantially vertical alignment of each of these components with the other, and by the substantially vertical orientation of the paper feed path 350. Further, the arrangement of the various components allows for ease of access to the toner cartridges 292, 294, 296 and 298, the paper trays 214 and 216, and the paper feed path 350 all from the same side of the printer 200.

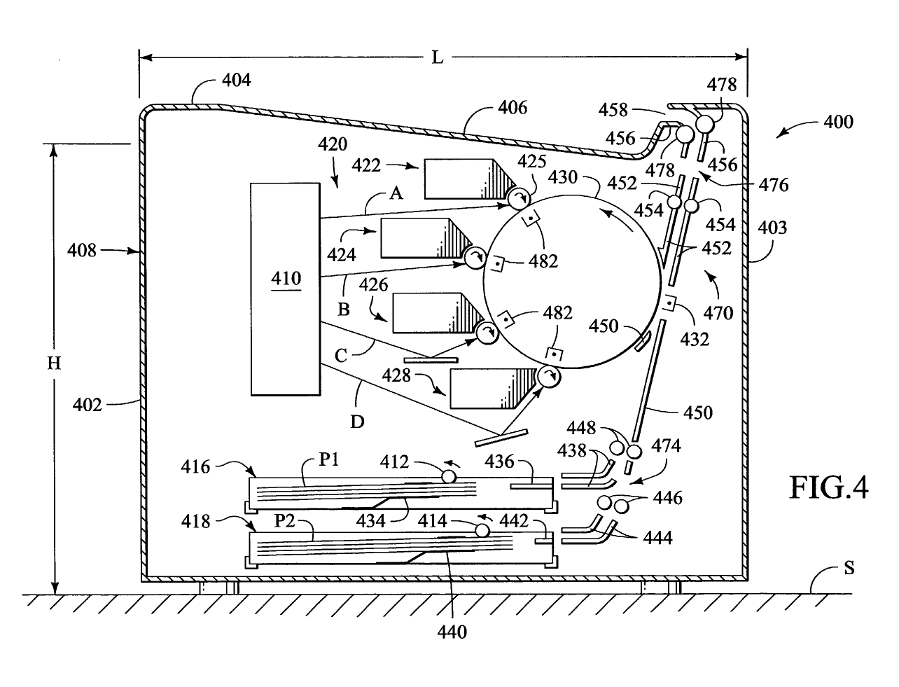

Turning now to FIG. 4, a second embodiment of an inline color electrophotographic imaging apparatus 400 in accordance with the present invention is depicted in a front elevation view. The view is similar to the view of printer 200 depicted in FIG. 3. It is understood that the printer 400 can including a housing 408 covering the various depicted components similar to the housing 208 of the printer 200 (FIG. 2). The housing 408 is defined by a left side 402, a right side 403, and a top 404. The printer is configured to be supported by an essentially horizontal surface S. The primary difference between printer 200 and printer 400 is that printer 400 uses a rotating drum 430 as the intermediate transfer device, rather than the transfer belt 300 of printer 200. Further, the toner cartridges 422, 424, 426 and 428 of the printer 400, and the scanner section 410, are essentially vertically oriented, as compared to the essentially horizontal orientation of the equivalent components in the printer 200. The configuration of the components in the printer 400 can result in a printer which has a shorter length L than the printer 200, but which may have a taller height H. I will now describe the printer 400 in more detail.

Printer 400 is configured to receive at least one, and preferably two, finished product medium feed trays 416 and 418. These feed trays are preferably removable from the printer 400, and can be arranged and operate in a manner similar to the feed trays 214 and 216 of the printer 200. That is, feed tray 416 can contain finished product media P1, and feed tray 418 can contain finished product media P2. Spring 434 biases media P1 against feed roller 412, and spring 440 biases media P2 against feed roller 414. Guide plate 436 guides media P1 from tray 416 into the paper feed path input area guides 438, while guide plate 442 guides media P2 from tray 418 into the paper feed path input area guides 444. The printer 400 can also incorporate a bypass receptacle (not shown) similar to the bypass tray 460 of FIG. 3.

The printer 400 further includes a scanning section 410 which includes scanning lasers (not shown) and at least one rotating, polygonal mirror to scan the laser beams across photoconductors in the developing section 420. The scanning section can generate beams A, B, C and D. Beams C and D are directed to their respective photoconductors by deflecting mirrors (shown but not numbered). The developing section 420 includes developing stations (toner cartridges) 422, 424, 426 and 428. Each toner cartridge has a toner hopper and a photoconductor to allow toner to be applied to the intermediate transfer device 430 using the toner transfer modules 482 in a manner similar to that described above for printer 200. Developer station 422 is depicted with exemplary photoconductor 425. The intermediate transfer device, which in this embodiment is a rotating drum 430, transfers toner from the toner cartridges to a location adjacent to the paper feed path 470 where a toner transfer unit 432 is located. A sheet of printable medium (for example, paper) moving in the finished product medium feed path 470 passes between the rotating drum 430 and the toner transfer unit 432, and the toner transfer unit causes toner to be transferred from the rotating drum to the sheet of printable medium. The toner is then fixed to the sheet of printable medium using fusing rollers 454 or other known means for fixing toner to a sheet of printable medium. This process was described more fully above with respect to printer 200.

The printer 400 also includes a finished product medium feed path (or “paper path”) 470. Finished product medium enters the feed path from a finished product medium input area 474, and exits the feed path at a finished product medium output area 476. Sheets of printable medium enter the input area 474 of the feed path 470 from either paper tray 416 or 418 via respective feed path input guides 438 and 444. Once a sheet of printable medium has entered the feed path 470 it is urged upward towards the toner transfer module by powered feed rollers 448 and paper guides 450. As the sheet moves past the toner transfer module 432 and the intermediate transfer device toner is applied to the sheet. The sheet is then guided to the fusing rollers 454 by guides 452, and leaves the feed path at output area 476. Sheets of printed medium exiting the output area 476 are guided to a printed medium discharge receptacle 406 by output guides 456, and can be facilitated in moving into the discharge tray 406 by output drive rollers 478.

Preferably the discharge receptacle 406 is substantially parallel to the horizontal surface S. By “substantially parallel to” I mean that a sheet of medium which has been discharged into the discharge receptacle 406 is at an angle of about 35 degrees or less with respect to the surface S. More preferably, the printed medium receptacle 406 is substantially vertically aligned with the printable medium feed trays 416 and 418. Also, preferably, the finished product medium feed path 470 is oriented such that a sheet of finished product medium traveling in the feed path between the input area 474 and the output area 476 travels in a substantially vertical direction with respect to the surface S on which the printer 400 is intended to be supported. By “a substantially vertical direction” I mean that a sheet of medium in the feed path is perpendicular to, or at an angle of not more than about 35 degrees from normal to, the horizontal surface S. A substantial vertical orientation of the paper feed path 470, in conjunction with the preferred arrangement of the other components as described above, aids in reducing the surface area which will be occupied by the printer 400 on the supporting surface S.

A third embodiment of the invention comprises a method of printing an electrophotographic image on a finished product medium. The method is particularly applicable to printing a color image using an electrophotographic imaging device, and more particularly an inline imaging device. The method includes the step of providing a finished product medium onto which the electrophotographic image is to be printed. For example, printable media such as paper can be provided in a paper tray, such as tray 214 of FIG. 3. The method further includes providing an intermediate transfer medium configured to support a plurality of color toners which will be used to generate the electrophotographic image on the finished product medium. For example, transfer belt 300 of FIG. 3 can be used to support toner from toner cartridges 292, 294, 296 and 298. Another step in the method is providing a finished product medium receptacle such as receptacle 206 of FIG. 3. The receptacle should be configured to contain the finished product medium after the electrophotographic image has been printed onto the finished product medium.

In the method the finished product medium is initially orienting in a substantially horizontal position, such as depicted for media P1 and P2 in FIG. 3. A plurality of color toners are selectively deposited onto the intermediate transfer medium to generate a representation of the image on the intermediate transfer medium. This is typically accomplished using a scanning section, such as scanning section 280 in FIG. 3, in conjunction with the developer stations 292, 294, 296 and 298 and the toner transfer units 302. Then the finished product medium is moved from the substantially horizontal position to a substantially vertical position while moving the finished product medium past the intermediate transfer medium. This last step can be performed for example by moving a sheet of printable medium P1 (FIG. 3) from paper tray 214 into the feed path 350 via guides 324, and moving the sheet up to the toner transfer unit 306 which is proximate the transfer belt 300. Color toner is then transferred from the intermediate transfer medium to the finished product medium. The finished product medium is then moved from the substantially vertical position to a substantially horizontal position and placed in the finished product receptacle. This step can be accomplished using the discharge guides 334 (FIG. 3) to turn the sheet of printed medium from the substantially horizontal position to the substantially horizontal position. When I say “substantially horizontal”, I mean within about 35 degrees or less from true horizontal. When I say “substantially vertical”, I mean within about 35 degrees or less from true vertical.

The method can further include the step of moving the intermediate transfer medium in a substantially horizontal direction while selectively depositing a plurality of color toners onto the intermediate transfer medium. This can be accomplished for example by using a substantially horizontally oriented transfer belt, such as transfer belt 300 depicted in FIG. 3, in conjunction with toner cartridges 292, 294, 296 and 298 which are in substantial horizontal alignment.

The method can also include the step of moving the intermediate transfer medium in a substantially vertical direction while transferring color toner from the intermediate transfer medium to the finished product medium. This can be accomplished for example by using the arrangement of the intermediate transfer belt 300 depicted in FIG. 3. While the transfer belt 300 has a substantial horizontal component relative to the developing section 290, the belt also has a substantially vertical component in the area proximate the toner transfer module 306 in the feed path 350.

Preferably, in the method the finished product medium is placed in the finished product receptacle in a position substantially vertically aligned with the initial position in which the finished product medium was oriented. This can be accomplished for example by using the printer 200 of FIG. 3. That is, because the discharge tray 206 which is used to receive the printed medium is substantially vertically aligned with the feed tray 214 which contains the printable media P1, the finished product medium will be placed in the finished product receptacle in a position substantially vertically aligned with the initial position in which the finished product medium was oriented.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An inline electrophotographic color imaging apparatus configured to be supported by an essentially horizontal surface, comprising:
a developing section configured to receive a plurality of removable color toner cartridges;
an intermediate transfer device configured to receive color toner from the color toner cartridges;
a feed tray receptacle configured to receive a finished product medium feed tray containing finished product medium onto which an electrophotographic color image can be printed;
a finished product medium feed path configured to move finished product medium from the feed tray past the intermediate transfer device to allow toner from the intermediate transfer device to be transferred to the finished product medium; and
wherein, the feed tray receptacle is positioned below the intermediate transfer device, and the finished product medium feed path is configured to pass finished product medium past the intermediate transfer device in a substantially vertical direction relative to the essentially horizontal surface.

2. The apparatus of claim 1, and further wherein each color toner cartridge comprises a photoconductor configured to receive color toner from the color toner cartridge and present the color toner to the intermediate transfer medium, the imaging apparatus further comprising a scanning section configured to scan a plurality of selectively pulsed laser beams onto the photoconductors.

3. The apparatus of claim 1, and further wherein the developing section is configured to receive the plurality of removable color toner cartridges in a substantially horizontal direction relative to the essentially horizontal surface.

4. The apparatus of claim 3, and further wherein the plurality of removable color toner cartridges are configured to be received within the developing section in a location above the intermediate transfer device.

5. The apparatus of claim 3, and further wherein the intermediate transfer device comprises a rotating belt configured to move past the color toner cartridges and at least a portion of the finished product medium feed path.

6. The apparatus of claim 1, and further comprising a finished product medium discharge tray, and wherein the finished product medium feed path is configured to discharge finished product medium in the discharge tray after the finished product medium has moved past the intermediate transfer device.

7. The apparatus of claim 6, and further wherein the finished product medium discharge tray is positioned above the intermediate transfer device.

8. The apparatus of claim 1, and further wherein the intermediate transfer device comprises a rotating drum configured to move past the color toner cartridges and at least a portion of the finished product medium feed path.

9. An inline electrophotographic color imaging apparatus configured to be supported by an essentially horizontal surface, comprising:
a housing;
a developing section located within the housing and comprising a plurality of removable color toner cartridges;
an intermediate transfer device located within the housing and configured to receive color toner from the color toner cartridges;
a feed receptacle configured to receive finished product medium onto which an electrophotographic color image can be printed;
a finished product medium feed path having a finished product medium input area and a finished product medium output area, and configured to move finished product medium from the feed receptacle into the input area and past the intermediate transfer device and to the output area;
a finished product medium discharge receptacle formed in the housing above the intermediate transfer device;
a discharge receptacle guide positioned at the output area of the feed path and configured to guide finished product medium from the feed path output area into the finished product medium discharge receptacle; and
wherein:
the feed receptacle is positioned below the intermediate transfer device;
the finished product medium feed path is oriented in a substantially vertical direction relative to the essentially horizontal surface; and
the discharge receptacle is oriented in a substantially horizontal direction relative to the essentially horizontal surface.

10. The apparatus of claim 9, and further comprising a toner transfer module positioned between the input area and the output area of the feed path and proximate the intermediate transfer device such that finished product medium moving within the feed path will be disposed between the toner transfer module and the intermediate transfer device.

11. The apparatus of claim 9, and further wherein the feed receptacle is oriented such that finished product medium received within the feed receptacle is oriented substantially parallel to the essentially horizontal surface.

12. The apparatus of claim 9, and wherein the feed receptacle is a first feed receptacle, the apparatus further comprising a second feed receptacle configured to receive finished product medium onto which an electrophotographic color image can be printed, and wherein the second feed receptacle is positioned below the first feed receptacle, and feed path is further configured to move finished product medium from the second receptacle into the input area.

13. The apparatus of claim 12, and further wherein the first and second feed receptacles are oriented such that finished product medium received within the feed receptacles is oriented substantially parallel to the essentially horizontal surface.

14. The apparatus of claim 13, and further comprising a third feed receptacle configured to receive finished product medium onto which an electrophotographic color image can be printed, and wherein the third feed receptacle is hingedly attached to the housing, and the housing defines an opening allowing finished product medium to pass from the third feed receptacle into the input area of the feed path.

15. The apparatus of claim 9, and wherein the intermediate transfer device is a continuous rotating belt configured to move past the color toner cartridges and at least a portion of the finished product medium feed path.

16. The apparatus of claim 15, and wherein the color toner cartridges are oriented in a substantially horizontal direction relative to the essentially horizontal surface.

17. A method of printing an electrophotographic image on a finished product medium, comprising:
providing the finished product medium onto which the electrophotographic image is to be printed;
providing an intermediate transfer medium configured to support a plurality of color toners which will be used to generate the electrophotographic image on the finished product medium;
providing a finished product medium receptacle configured to contain the finished product medium after the electrophotographic image has been printed onto the finished product medium;
initially orienting the finished product medium in a substantially horizontal position;
selectively depositing a plurality of color toners onto the intermediate transfer medium to generate a representation of the image on the intermediate transfer medium;
moving the finished product medium from the substantially horizontal position to a substantially vertical position while moving the finished product medium past the intermediate transfer medium;
transferring color toner from the intermediate transfer medium to the finished product medium;
moving the finished product medium from the substantially vertical position to a substantially horizontal position; and
placing the finished product medium in the finished product receptacle.

18. The method of claim 17, and further comprising moving the intermediate transfer medium in a substantially horizontal direction while selectively depositing a plurality of color toners onto the intermediate transfer medium.

19. The method of claim 18, and further comprising moving the intermediate transfer medium in a substantially vertical direction while transferring color toner from the intermediate transfer medium to the finished product medium.

20. The method of claim 17, and wherein the finished product medium is placed in the finished product receptacle in a position substantially vertically aligned with the initial position in which the finished product medium was oriented.
